(19) United States
(12) Patent Application Publication
(10) Pub. No.: US 2004/0145646 A1
(43) Pub. Date: Jul. 29, 2004

(54) Device for producing a printing form

(76) Inventors: Andreas Detmers, Heddesheim (DE); Claus Harbach, Borgdorf (DE); Bernd Lassen, Monkeberg (DE); Sven Mader, Dielheim (DE); Christian Meier, Schriesheim (DE); Burkhard Paasch, Wahlstorf (DE); Lars Paulsen, Hollingstedt (DE); Markus Uihlein, Heidelberg (DE); Bernhard Zintzen, Heidelberg (DE)

Correspondence Address: LERNER AND GREENBERG, P.A., POST OFFICE BOX 2480, HOLLYWOOD, FL, 33022-2480, US

(21) Appl. No.: 10/753,003

(22) Filed: Jan. 7, 2004

(30) Foreign Application Priority Data
Jan. 7, 2003 (DE) 103 00 163.8

(51) Int. Cl. B41J 29/377; B41J 2/435

(52) U.S. Cl. 347/242

(57) ABSTRACT

A device for producing a printing form includes a printing form carrier, a holder and an imaging head fixed to the holder. The imaging head has at least one radiation source and is positionable along a printing form blank for directing radiation onto the printing form blank for producing printing ink-accepting image points in accordance with an image. A tempering or temperature control configuration is provided for the holder.

### BACKGROUND OF THE INVENTION

1. Field of the Invention

The invention relates to a device for producing a printing form, including a printing form carrier having an imaging head, and a holder to which the imaging head is fixed. The imaging head has at least one radiation source and is positionable along a printing form blank for directing radiation onto the printing form blank to produce printing ink-accepting image points in accordance with an image.

Heretofore-known devices for producing a printing form employ an imaging or imagesetting head with a radiation source, in particular with a laser diode array. The radiation source is controlled in accordance with an image. When a laser is activated, an image point or a non-image point is produced on a printing form blank coated with a light-sensitive material. The printing form blank, in the form of a plate, film or sleeve, is accommodated on a cylinder or is disposed on a flat support table. The imaging head is moved relative to the printing form blank in order to be able to cover the entire surface of a printing form blank.

In order to increase productivity, it has become known heretofore to use a plurality of imaging heads in parallel. For that purpose, the imaging heads are mounted on a common holder and are positioned relative to the printing form blank together in a linear guide, for example on a carriage. During the operation of imaging heads equipped with laser diode arrays, heat is produced, which has to be dissipated by a cooling device. Optically imaging elements having properties which are highly temperature-dependent serve for producing image points and non-image points, respectively. In order to ensure that the image points or non-image points are placed accurately on the printing form blank in the micron range, it is necessary to temper or control the temperature of the optoelectrical subassemblies. Usually, a streaming or flowing tempering medium, which is fed by suitable lines to the imaging heads, is provided for that purpose. The temperature of the tempering or temperature control medium is regulated or controlled in such a manner that the desired temperature is provided on the optoelectronic subassemblies. An interfering variable which appears during the control or regulation of the temperature is the ambient temperature of the imaging or imagesetting head. In particular, if devices for producing printing forms are integrated into printing presses, severe fluctuations of the ambient temperatures occur, which can only be inadequately compensated for. The ambient temperature fluctuations additionally effect longitudinal expansions in a holder for a plurality of imaging heads, so that impermissible changes occur in the spacing or distance of the optoelectronic subassemblies from one another, resulting in the occurrence of image errors during imaging or imagesetting.

In order to stabilize the printing process, it has become known heretofore to set up printing presses or printing devices in air-conditioned rooms. Furthermore, it has become known heretofore to encapsulate printing presses with respect to the outside and to maintain a dedicated climate in the interior. Such globally acting tempering or temperature control devices are incapable of satisfying the special requirements in the temperature control of imaging or imagesetting devices, which are required to operate accurately in the micron range.

In further heretofore-known improvements, temperature-sensitive optoelectronic components are isolated thermally from possible interfering sources. Improved embodiments of that type are complicated and require a large amount of installation space.

### SUMMARY OF THE INVENTION

It is accordingly an object of the invention to provide a device for producing a printing form, which overcomes the hereinafore-mentioned disadvantages of the heretofore-known devices of this general type and which permits improved tempering or temperature control of components that can be influenced by temperature.

With the foregoing and other objects in view, there is provided, in accordance with the invention, a device for producing a printing form, comprising a printing form carrier having an imaging head, and a holder to which the imaging head is fixed. The imaging head has at least one radiation source and is to be positioned along a printing form blank for directing radiation onto the printing form blank to produce printing ink-accepting image points in accordance with an image. A tempering or temperature control configuration is provided for the holder.

In accordance with another feature of the invention, the printing-form producing device further includes a tempering or temperature control configuration for the imaging head. Both the tempering or temperature control configuration of the holder and the imaging head are provided with a common tempering or temperature control medium.

In accordance with a further feature of the invention, the tempering or temperature control medium is a liquid. In accordance with an added feature of the invention, the liquid is water. In accordance with an additional feature of the invention, the water has a corrosion-prevention and/or antifreeze additive.

In accordance with yet another feature of the invention, the holder is formed with at least one respective forward flow and return duct for the water.

In accordance with yet a further feature of the invention, the imaging head is formed with at least one coolant duct connected to the forward flow and the return duct.

In accordance with yet an added feature of the invention, the tempering or temperature control configuration includes a control device to which a nominal temperature value is to be fed for controlling the temperature of the imaging head.

In accordance with a concomitant feature of the invention, the holder is horizontally disposed with at least two ducts for a tempering or temperature control medium disposed therein vertically above one another at the respective top and bottom of the holder. The medium in the respective duct located at the bottom of the holder has a lower temperature than the medium in the respective duct located at the top of the holder.

Due to the provision of a tempering or temperature control configuration for a holder of one or more imaging heads, it thus becomes possible to control the temperature of the surroundings of an imaging head over a large space. Furthermore, it is possible to deform the holder, such as a crossmember, specifically for compensating for impermissible bending. The temperature gradient between an imaging head and the surroundings thereof is reduced considerably, so that the control of the temperature of an imaging head and the optoelectronic components contained therein can be carried out more quickly, more accurately and with less use of a temperature control medium than has been necessary heretofore. If only one circuit for a temperature control medium, such as water, is provided, flow can take place during forward flow and during return flow both through the holder and the components of an imaging head. Temperature-induced expansions and tolerances on the imagesetting head, on the holder and on a positioning system for an imaging head are reduced to a minimum. Virtually all imaging heads are always operated at a constant temperature, assisted by a housing which is encapsulated with respect to the outside.

In the case of systems with spindle positioning of the imaging heads, virtually no temperature-induced longitudinal change takes place, so that the positioning accuracy of an imaging head is improved. A constant operating temperature of an imaging head also improves the dissipation of heat from electronic components within an imaging head.

In the case of systems wherein a plurality of imaging heads are held jointly on a carriage, the distances between the imaging heads do not change. Consequently, no so-called line connection errors are produced in the printed image between two lines which are produced by different imaging heads.

Tempering or controlling the temperature of the holder of imaging heads achieves the result of reducing the expenditure for lines for the tempering or temperature control of components within an imaging head. The ducts for circulation of a tempering or temperature control medium in the holder can serve simultaneously as forward flow and return lines for tempering or controlling the temperature of one or more imaging heads. The holder itself represents a heat storage device which does not permit any rapid temperature fluctuations. As a result, the tempering or temperature control becomes more independent of fluctuations which are caused by a tempering or temperature control unit itself or by other interfering sources in the surroundings.

The tempering or temperature control medium provided for the holder can advantageously be water, preferably with a corrosion-prevention and/or antifreeze additive.

Other features which are considered as characteristic for the invention are set forth in the appended claims.

Although the invention is illustrated and described herein as embodied in a device for producing a printing form, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic perspective view of a temperature control system for a device for producing a printing form in accordance with the invention;

FIG. 2 is a side-elevational view of a crossmember formed of an aluminum extruded section;

FIG. 2A is a cross-sectional view of FIG. 2, taken along a line IIA-IIA thereof, in the direction of the arrows;

FIG. 3 is a side-elevational view of a crossmember formed of gray cast iron;

FIG. 3A is a cross-sectional view of FIG. 3, taken along a line IIIA-IIIA thereof, in the direction of the arrows; and

FIGS. 4 and 5 are side-elevational views of crossmembers having compensation for bending of a crossmember.

### DESCRIPTION OF THE PREFERRED EMBODIMENTS

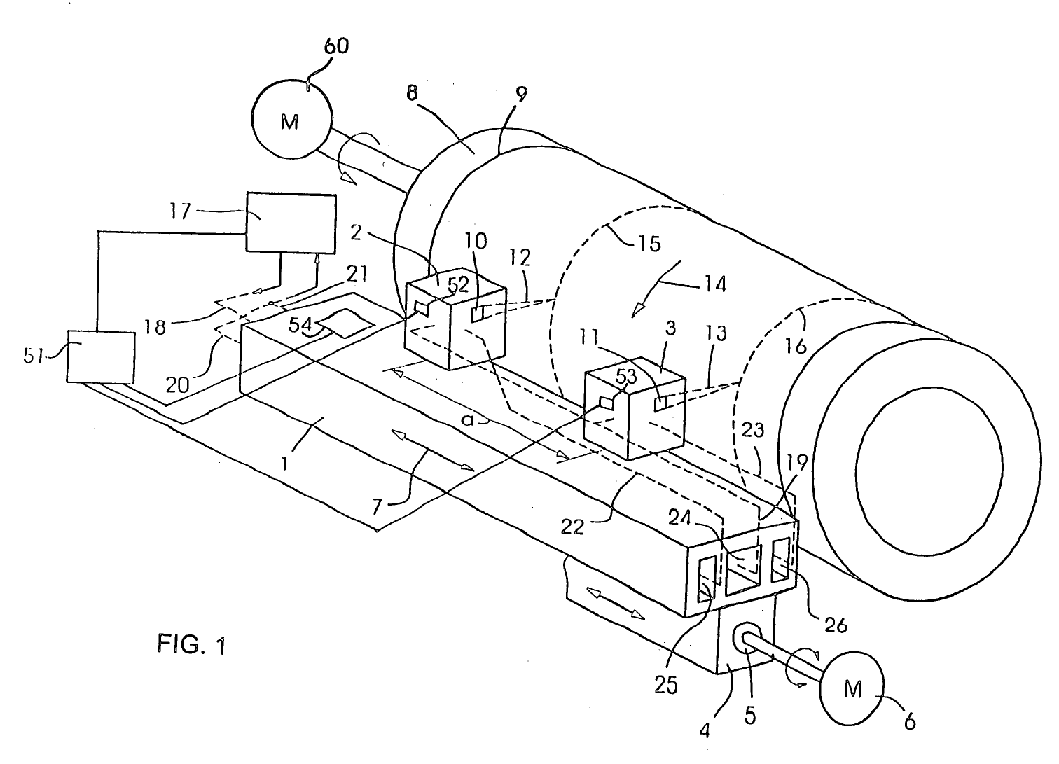

Referring now to the figures of the drawings in detail and first, particularly, to FIG. 1 thereof, there is seen a carriage or holder 1 whereon two imaging or imagesetting heads 2 and 3 are held at a fixed spaced distance a from one another. The carriage or holder 1 runs in a linear guide between two side walls of a printing press. The carriage 1 is coupled to a nut 4 of a spindle drive. The spindle drive has a spindle 5 which is connected to a stepping motor 6. The stepping motor 6 and the spindle drive serve for positioning the carriage 1 in a lateral direction represented by an arrow 7 between the side walls of the printing press. The direction represented by the arrow 7 extends parallel to the axis of rotation of a printing form cylinder or carrier 8 which is mounted in the non-illustrated side walls of the printing press. A printing form blank 9 is clamped onto the circumferential surface of the printing form cylinder or carrier 8. Each imaging or imagesetting head 2, 3 has a respective laser diode array 10, 11, electronic components for power supply and control of the lasers, and optoelectric components for focusing respective laser beams 12 and 13 onto the surface of the printing form blank 9. As the printing form cylinder 8 rotates in the direction of an arrow 14, driven by a motor 60, the laser diode arrays 10 and 11 are controlled in accordance with an image. In this regard, image points which accept printing ink are produced in tracks 15 and 16 on the printing form blank 9.

During imaging or imagesetting, heat is produced in the imaging or imagesetting heads 2 and 3 and is dissipated by a water cooling system. The water cooling system includes a water treatment or preparation device 17, flow lines 18 and 19, return lines 20 to 23 and a flow duct 24 and return ducts 25 and 26 within the carriage 1. The carriage 1 is implemented as a metallic extruded section or as a casting. The ducts 24 to 26 have end covers with connections for the flow and return lines 18 to 23. The cooling water is brought to a predetermined temperature in the water treatment device 17 and fed to the imaging heads 2 and 3 via the flow line 18, the flow duct 24 and the flow line 19. In the imaging heads 2 and 3, the cooling water flows through a respective heat exchanger to which the heat surrendering components are thermally coupled. In this regard, the water is heated and flows back to the water treatment device 17 via the return lines 22 and 23, the return ducts 25 and 26 and the return lines 20 and 21, respectively.

Due to the fact that the cooling water flows through the ducts 24 to 26 both during forward flow and during return flow, the carriage 1 assumes the temperature of the cooling water. The carriage 1 is a large-area component, so that the surroundings approximately assume the temperature of the carriage 1 by heat exchange. Therefore, the temperature of the imaging heads 2 and 3 is pre-controlled by the carriage 1. The temperature gradient between a respective imaging head 2, 3 and the carriage 1 is small, so that the tempering or regulation of the temperature of the imaging heads 2 and 3 is improved. The carriage 1 itself and the spindle 5 influenced by the temperature of the carriage 1 have a low thermal expansion due to the tempering or temperature control, so that no disruptive positioning errors of the imaging heads 2 and 3 in the lateral direction represented by the arrow 7 occur. Leading the lines to the water treatment device 17 and the imaging heads 2 and 3 is simplified by providing the ducts 24 to 26. In order to regulate the cooling water temperature, a control device 51 can be provided, which is connected to the water treatment device 17. Furthermore, respective temperature sensors 52, 53 and 54 can be provided on the imaging heads 2 and 3 and on the carriage 1, and can be connected to the control device 51.

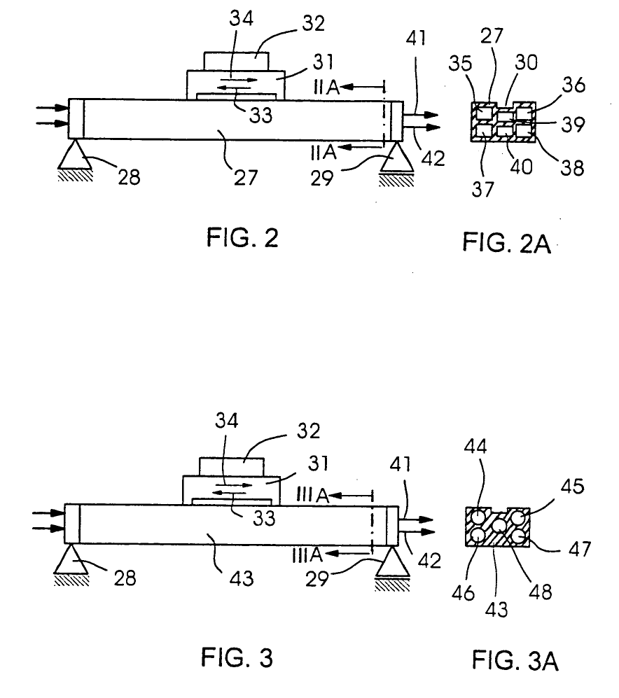

FIGS. 2, 2A, 3, 3A and 4 show different embodiments of crossmembers or traverses according to the invention. Ducts disposed vertically above one another are provided for cooling water, in order to additionally compensate for the deflection of a respective crossmember.

FIGS. 2 and 2A illustrate a crossmember or holder 27 which is formed of an aluminum extruded section. The crossmember 27 is held on a fixed bearing 28 and a sliding bearing 29. The crossmember 27 has a longitudinal guide 30 for a carriage 31 with an imaging or imagesetting head 32. The carriage 31 is reciprocatingly positionable in the direction of arrows 33 and 34 during imaging. As is shown in FIG. 2A, which is a cross-sectional view of FIG. 2 taken along a line IIA-IIA, the crossmember 27 is formed with rectangular ducts 35 to 40 which are closed by end plates and through which, to some extent, tempered or temperature-controlled water 41, 42 flows.

FIGS. 3 and 3A show a crossmember or holder 43 of gray cast iron formed with circular bores 44 to 47, as is shown in the cross-sectional view of FIG. 3A taken along a line IIIA-IIIA of FIG. 3. The circular bores 44 to 47 are closed by end plates.

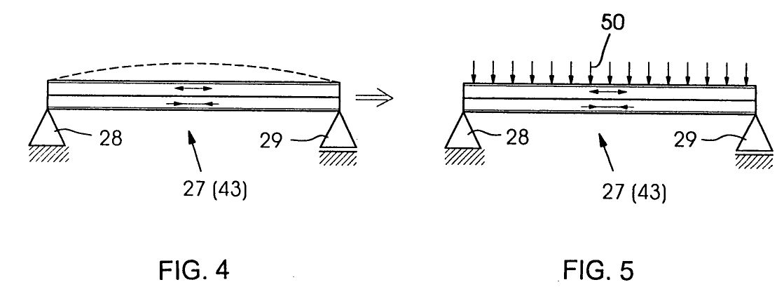

The crossmembers 27 and 43, the carriages 31 and the imaging heads 32 have a weight which would cause deflection of the crossmembers 27 and 43. Furthermore, forces and moments which can cause deflection act upon a respective crossmember 27, 43. In order to compensate for a deflection, the temperature of the water 41 in the upper ducts 35 and 36 or bores 44 and 45 located at the top of the respective crossmembers 27 and 43 can be set to be higher than the water 42 in the lower ducts 37 and 38 or bores 46 and 47. Without any weight forces, an opposite deformation, illustrated by a broken line in FIG. 4, would result in the crossmember 27 or 43. The opposite deformation is based upon different longitudinal expansions of the material of the respective crossmember 27, 43 in the regions above and below a neutral longitudinal center line. When the respective crossmember 27, 43 is loaded with usual weights 50, forces and moments, the respective crossmember 27, 43 will be directed or aligned rectilinearly, as is shown in FIG. 5. It is therefore possible to use crossmembers 27 and 43 which have a low flexural rigidity, resulting in a conservation of weight and material.

The tempering or temperature control of the crossmember 27, 43 can be coupled to the tempering or temperature control of a respective carriage 1 and 31. Therefore, cooling water flows through the respective crossmember 27, 43, the respective carriage 1, 31 and the respective imaging or imagesetting heads 2, 3, 32.

We claim:

1. A device for producing a printing form, comprising:
a printing form carrier;
a holder;
an imaging head fixed to said holder, said imaging head having at least one radiation source, and said imaging head to be positioned along a printing form blank on said printing form carrier for directing radiation onto the printing form blank to produce printing ink-accepting image points in accordance with an image; and
a tempering or temperature control configuration for said holder.

2. The printing-form producing device according to claim 1, further comprising a tempering or temperature control configuration for said imaging head, both said tempering or temperature control configuration for said holder and said tempering or temperature control configuration for said imaging head being provided with a common tempering or temperature control medium.

3. The printing-form producing device according to claim 2, wherein said tempering or temperature control medium is a liquid.

4. The printing-form producing device according to claim 3, wherein said liquid is water.

5. The printing-form producing device according to claim 4, wherein said water has a corrosion-prevention additive.

6. The printing-form producing device according to claim 4, wherein said water has an antifreeze additive.

7. The printing-form producing device according to claim 4, wherein said water has a corrosion-prevention additive and an antifreeze additive.

8. The printing-form producing device according to claim 4, wherein said holder has at least one forward flow duct and at least one return duct for the water.

9. The printing-form producing device according to claim 6, wherein said imaging head has at least one coolant duct connected to said at least one forward flow duct and to said at least one return duct.

10. The printing-form producing device according to claim 1, wherein said tempering or temperature control configuration includes a control device for receiving a nominal temperature value for controlling the temperature of said imaging head.

11. The printing-form producing device according to claim 1, wherein said holder is horizontally disposed, has a top and a bottom and has at least two ducts disposed therein vertically above one another respectively at said top and said bottom of said holder for receiving a tempering or temperature control medium, and the medium in said duct located at said bottom of said holder has a lower temperature than the medium in said duct located at said top of said holder.
